(19) United States
(12) Patent Application Publication
(10) Pub. No.: US 2003/0061862 A1
(43) Pub. Date: Apr. 3, 2003

(54) Gas concentration detection element

(76) Inventors: Tosiharu Kondo, Toyoake-city (JP); Minoru Ota, Okazaki-city (JP); Hiromi Sano, Nagoya-city (JP); Miho Ito, Hoi-gun (JP); Tomohiko Nakanishi, Nishio-shi (JP)

Correspondence Address: NIXON & VANDERHYE P.C., 1100 North Glebe Road, 8th Floor, Arlington, VA, 22201, US

(21) Appl. No.: 10/255,095

(22) Filed: Sep. 26, 2002

(30) Foreign Application Priority Data
Oct. 1, 2001 (JP) 2001-304886(PAT.A

(51) Int. Cl. G01N 7/00

(52) U.S. Cl. 73/23.31

(57) ABSTRACT

The invention provides a gas concentration detection element that can prevent the drop of catalytic activity due to thermal aggregation of catalyst particles under high temperature conditions, can maintain a stable output for a long time and can be easily produced at a low production cost. A reference electrode 12 is formed on an inner surface of a cup-like oxygen ion conductive solid electrolyte 11 and a detection electrode 13 is formed on its outer surface to constitute a gas concentration detection element 1 for detecting a specific gas component in a measured gas. A catalyst layer 15 is constituted by directly supporting a catalyst component on ceramic support particles, such as particles of element-substituted cordierite, through a chemical bond so that both bonding strength and durability can be improved.

### BACKGROUND OF THE INVENTION

1. Field of the Invention

This invention relates to a gas concentration detection element for detecting a specific gas component in a measured gas. More particularly, this invention relates to a gas concentration detection element applied to an oxygen sensor, for detecting the oxygen contained in an exhaust gas of an internal combustion engine and an air-fuel ratio, for example.

2. Description of the Related Art

A technology that detects an oxygen concentration in a gas emitted from an internal combustion engine and conducts feedback control of an air-fuel ratio has been employed in the past. A gas concentration detection element constituting the principal portion of the oxygen sensor generally includes a pair of electrodes formed on a surface of an oxygen ion conductive solid electrolyte such as zirconia. An exhaust gas is introduced to one of the electrodes and air as a reference gas, to the other, and the oxygen concentration is measured from the electromotive force developed between the pair of electrodes. A catalyst layer, generally fabricated by supporting a precious metal catalyst such as platinum or rhodium on support particles made of a porous ceramic material such as γ-alumina, is formed outside the electrode that comes into contact with the exhaust gas to minimize the influences of other gas components in the exhaust gas and to stabilize the output.

However, as the exhaust gas temperature has become higher in recent years, thermal degradation of the catalyst layer has becomes a serious problem. This is because the support particles are sintered and their specific surface area decreases as they are exposed to the high temperature, and the catalyst metal particles undergo thermal aggregation to invite grain growth. When the oxygen sensor is used inside the high temperature exhaust gas for a long time, its output becomes unstable due to the drop in catalytic activity. Therefore, it is necessary to increase the catalyst support amount in consideration of thermal degradation and the cost of production becomes higher.

For this reason, improving the high temperature durability of the catalyst layer has been a critical problem. Japanese Unexamined Patent Publication (Kokai) No. 7-134114, for example, describes a proposal that uses a heat-resistant ceramic such as θ-alumina as the support particles, heat-treats, in advance, the support particles and grows the particles of the catalyst metal to a particle size at which the grain growth at the exhaust temperature can be suppressed. However, this method needs the heat-treatment step for heat-treating in advance the particles supporting the catalyst to suppress the grain growth, and the production time and the production cost increase.

### SUMMARY OF THE INVENTION

It is an object of the invention to obtain an economical gas concentration detection element that can prevent the drop of catalytic activity due to thermal aggregation of catalyst particles, can provide a stable output for a long term and can be easily produced.

According to a first aspect of the invention, there is provided a gas concentration detection element for detecting a specific gas component in a measured gas, including a catalyst layer formed outside a detection electrode, wherein the catalyst layer comprises ceramic support particles and a catalyst component supported by the ceramic support particles through a chemical bond.

In the catalyst layer according to the prior art, the support particles support the catalyst component through physical adsorption. Therefore, the catalyst particles readily move due to thermal oscillation and thermal aggregation occurs. In contrast, in the catalyst layer of the invention described above, the catalyst component is chemically bonded to the substrate ceramic, and the bonding strength is far higher than that of the catalyst layer of the prior art. Therefore, even when the catalyst layer is exposed to a high temperature, the catalyst component does not easily move and thermal degradation is suppressed with, as a result, a drastic improvement in durability. Therefore, it is not necessary to increase the catalyst support amount in view of thermal degradation, or to conduct pre-heat-treatment, and a high performance can be maintained for a long time.

According to a second aspect of the invention, there is provided a gas concentration detection element of the type described above, wherein the detection electrode is disposed on a surface of an oxygen ion conductive solid electrolyte in contact with the measured gas. At this time, a reference electrode is disposed on a surface of the oxygen ion conductive solid electrolyte in contact with a reference gas. Since an electromotive force is developed between the electrodes in accordance with the difference of the specific gas component in the measured gas and in the reference gas, the concentration of the specific gas can be detected on the basis of this electromotive force.

According to a third aspect of the invention, at least one kind of element constituting the substrate ceramic is substituted by an element other than the constituent elements in the ceramic support particles, and the catalyst component is directly supported on the substitution element. When a substitution element capable of chemically bonding with the catalyst component is introduced, for example, a ceramic that could not be used as the support, due to its small specific surface area, can now directly support the catalyst component. The effect of suppressing degradation resulting from aggregation is high because the retaining property can be improved and the catalyst component can be uniformly dispersed.

According to a fourth aspect of the invention, the substitution element is at least one kind of element having a d or an f orbit in the electronic orbits thereof. An element having a d or an f orbit in its electronic orbits is suitable because it easily bonds with the catalyst component.

According to a fifth aspect of the invention, a ceramic material containing cordierite as a principal component thereof is appropriately used for the substrate ceramic described above. Cordierite is excellent in heat resistance and does not undergo thermal degradation even when used at a high temperature. Therefore, it effectively exhibits the function of the catalyst layer.

According to a sixth aspect of the invention, the gas concentration detection element may further include a coating layer for covering a surface of the detection electrode. The coating layer protects the electrode surface and prevents the catalyst layer from affecting the detection element.

According to a seventh aspect of the invention, the gas concentration detection element may further include a trap layer for collecting poisoning components outside the coating layer. The trap layer can collect the poisoning components before they reach the catalyst layer, and a drop in the catalyst performance can be effectively suppressed.

According to a eighth aspect of the invention, the catalyst layer described above may be formed between the coating layer and the trap layer. Alternatively, the coating layer or the trap layer may function also as the catalyst layer.

According to a ninth aspect of the invention, when the measured gas is an exhaust gas of an internal combustion engine, oxygen as the specific gas component can be detected. When the oxygen concentration is detected, an air-fuel ratio can be easily controlled.

According to a tenth aspect of the invention, the gas concentration detection element can be used as an oxygen sensor for detecting electromotive force occurring between the detection electrode and the reference electrode. Alternatively, the gas concentration detection element can be used as an air-fuel ratio sensor for detecting a threshold current flowing between the detection electrode and the reference electrode when a predetermined voltage is applied between them.

### BRIEF DESCRIPTION OF THE DRAWINGS

FIG. 1 is an enlarged sectional view of the principal portions of a gas detection element according to a first embodiment of the invention;

FIG. 2 is an overall sectional view of an oxygen sensor using the gas detection element of the first embodiment;

FIG. 3 shows a relation between a durability time and a response time;

FIGS. 4(a) and 4(b) show a second embodiment of the invention, wherein FIG. 4(a) is an overall sectional view of an oxygen sensor and FIG. 4(b) is an enlarged sectional view of the principal portions of the oxygen sensor;

FIG. 5 is an enlarged sectional view of the principal portions of a gas detection portion according to another embodiment of the invention; and

FIG. 6 is an enlarged sectional view of the principal portions of a gas detection portion according to still another embodiment of the invention.

### DESCRIPTION OF THE PREFERRED EMBODIMENTS

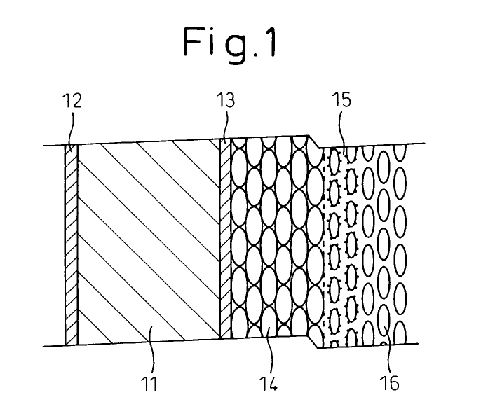

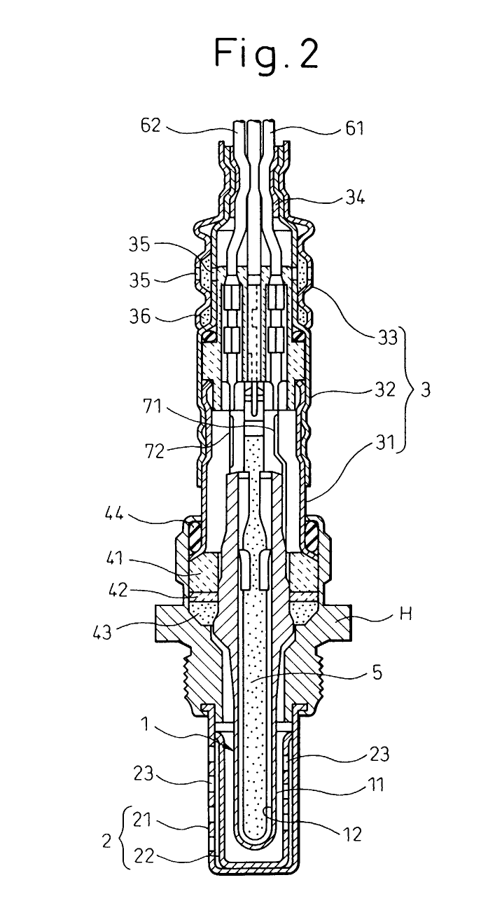

The first embodiment of the invention will be initially explained with reference to FIGS. 1 to 3. FIG. 2 shows an overall construction of an oxygen sensor to which the invention is applied. A gas concentration detection element 1 according to the invention is fitted to, and held by, a cylindrical housing H that is in turn fitted to a wall of an exhaust pipe of an internal combustion engine not shown in the drawing. A portion of the housing H below its flange portion protruding from an outer circumference at the central portion of the housing H is fitted and screwed into a fitting hole formed in the exhaust pipe. The housing H is thus fixed. The gas concentration detection element 1 has a substantially cup-like shape and its upper end part is open. A lower end part of the detection element 1 protruding from the housing H is accommodated inside an exhaust-side cover 2 fixed to the lower end of the housing H. Insulating members 41, 42 and 43 are installed between the housing H and the detection element 1. The exhaust-side cover 2 positioned inside the exhaust pipe has a double-cylinder shape, and a plurality of gas holes 23 is formed on the side of each of the outer and the inner cylinders 21 and 22. An exhaust gas as a measured gas is introduced into the exhaust-side cover 2 through these gas holes 23.

The upper end part of the gas concentration detection element 1 is accommodated inside an atmospheric air-side cover 3. The atmospheric air-side cover 3 includes a first cover 31 anchored to the upper end of the housing H, a second cover 32 put on an upper half portion of the first cover 31 and a third cover 33 put to an upper half portion of the second cover 32. A rubber bush 34 closes an opening at the upper end of the atmospheric air-side cover 3. A seal ring 44 is interposed between the housing H and the first cover 31. A plurality of vent holes 35 is formed at opposing positions of the side surfaces of the second and third covers 32 and 33 so that atmospheric air, as a reference gas, can be introduced into the atmospheric air-side cover 3 through these vent holes 35. A water-repellent filter 36 is arranged for water proofing between the second and third covers 32 and 33 at the formation positions of the vent holes 35.

The gas concentration detection element 1 described above has an oxygen ion conductive solid electrolyte 11 substantially shaped into a cup-shape and a pair of electrodes (not shown in the drawing) formed on the inner and outer surface of the solid electrolyte 11. The pair of electrodes is respectively connected to lead wires 61 and 62 for taking out an output through output terminals 71 and 72. The lead wires 61 and 62 extend outward through the rubber bush 34. A heater 5 is arranged inside a hollow portion of the gas concentration detection element 1 and generates heat when electric power is supplied thereto from outside. The heater 5 is formed, for example, by burying a heat generation member such as tungsten (W) or molybdenum (Mo) in a ceramic material such as alumina (Al₂O₃) shaped into a rod shape, and heats the gas concentration detection element 1 that opposes the heater 5 at a predetermined distance.

FIG. 1 is an enlarged view that shows a detailed construction of the gas concentration detection element 1. An inner electrode 12 as a reference electrode is formed to extend on an inner peripheral surface of the oxygen ion conductive solid electrolyte 11 while an outer electrode 13, as a detection electrode, is formed to extend on an outer peripheral surface. A ceramic material that exhibits oxygen ion conductivity such as a zirconia-yttria (Zr₂O₃—Y₂O₃) type ceramic is appropriately used for the oxygen ion conductive solid electrolyte. For example, 5 mol% of Y₂O₃ is mixed with Zr₂O₃, pulverized and dried by use of a spray dryer. The mixture is then molded and cut into the shape shown in the drawing, and is baked at 1,600° C. for 2 hours to give the oxygen ion conductive solid electrolyte.

The electrodes 12 and 13 are porous electrodes formed of platinum (Pt), for example, and are formed by rendering the surface of the oxygen ion conductive solid electrolyte 11 rough by use of a strong acid, and then conducting chemical plating. Other means such as vacuum deposition can also be used for forming these electrodes.

A coating layer 14 is formed on the outer surface of the outer electrode 13. The coating layer 14 is formed of a porous ceramic material, such as spinel (MgO.Al₂O₃), and prevents a later-appearing catalyst layer 15 from affecting the detection element and protects the surface of the outer electrode 13. Generally, the thickness of the coating layer 14 is preferably within the range of about 50 to about 150 μm.

A catalyst layer 15 as the characterizing portion of the invention is formed on the outer surface of the coating layer 14. The catalyst layer 15 includes ceramic support particles and a catalyst component directly supported by the ceramic support particles through a chemical bond. A substrate ceramic of the ceramic support particles preferably consists, as the principal component, of a ceramic material having high heat resistance such as cordierite the theoretic composition of which is expressed by 2MgO.2Al₂O₃.5SiO₂. A precious metal catalyst such as Pt or Rh can be appropriately used for the catalyst component. Incidentally, it is possible to use ceramic materials such as alumina, spinel, aluminum titanate, silicon carbide, mullite, silica-alumina, zeolite, zirconia, silicon nitride and zirconium silicate besides cordierite.

Unlike the catalyst layers of the prior art in which the catalyst component is supported on the surface of the ceramic having a large specific surface area through physical adsorption, the catalyst component and the ceramic in the invention are chemically bonded to each other. For this reason, the ceramic support particles have on the surface thereof a large number of elements having the catalyst supporting function. More concretely, an element that can be chemically bonded to the catalyst component other than the constituent elements of the ceramic replaces one or more kinds of elements of the constituent elements of the ceramic (with the exception of oxygen), and the catalyst component can be directly supported on this substitution element. In the case of cordierite, for example, Si, Al and Mg as the constituent elements may well be substituted by elements having greater bonding strength with the catalyst component to be supported than these constituent elements and capable of supporting the catalyst component through the chemical bond.

Concretely, the substitution elements are different from the constituent elements and have a d or an f orbit in the electron orbit thereof. In this case, it is more preferred to use elements having an empty orbit in the d or f orbits or elements having at least two oxygen states. For, elements having the empty orbit in the d or f orbits have an energy level approximate to that of the catalyst component to be supported, so that the electrons are more likely to be exchanged and to combine with the catalyst component. A similar effect can be expected of elements having two oxygen states because the exchange of the electrons is more likely to occur.

Concrete examples of the elements having an empty orbit in the d or f orbits include W, Ti, V, Cr, Mn, Fe, Co, Ni, Zr, Mo, Ru, Rh, Ce, Ir and Pt. One or more kinds of these elements can be used. Among these elements, W, Ti, C, Cr, Mn, Fe, Co, Mo, Ru, Rh, Ce, Ir and Pt are the elements that have two or more oxygen states. Concrete examples of other elements having two or more oxygen states are Cu, Ga, Ge, Se, Pd, Ag and Au.

To produce the ceramic support particles, the constituent elements of which are partly replaced by these substitution elements, the amounts of the constituent elements to be substituted are partly decreased in advance in accordance with the substitution amounts when the ceramic materials are prepared, and the starting materials of the substitution elements are added in the amounts corresponding to the substitution amounts. Thereafter, the starting materials are mixed, molded and dried in a customary manner and are then baked in the atmospheric air atmosphere. Alternatively, the ceramic materials in which a part of the materials of the substitution elements are partly decreased in accordance with the substitution amounts are mixed, molded and dried in the customary manner, and are then impregnated with a solution containing the substitution elements, dried and baked in the atmospheric air atmosphere.

The amount of each substitution element is such that the total substitution amount is at least 0.01% to 50%, preferably within the range of 5 to 20%, of the atomic number of the elements to be substituted. When the substitution element is an element having a different valence number from that of the constituent elements of the ceramic, a lattice defect or an oxygen defect simultaneously occurs in accordance with the difference in the valence numbers as described above. However, this defect does not occur when a plurality of substitution elements is used in such a fashion that the sum of the oxidation number of the substitution elements is equal to the sum of the oxidation number of the constituent elements to be substituted.

The catalyst layer 5 is formed in the following way. First, the ceramic support particles into which the substitution elements are introduced are impregnated with a catalyst solution containing Pt, Rh, or the like, until desired amounts of the catalyst components are supported. After the catalyst components are supported in this way, the ceramic support particles (in which the substitution elements of the ceramic and the catalyst components are chemically bonded at this point) are pulverized to a desired particle size. A binder and water, etc, are further added and mixed to form slurry. The resulting slurry is applied to the surface of the coating layer 14 and is baked at a temperature of about 500 to about 900° C. The thickness of the catalyst layer 15 is preferably from about 10 to about 100 μm in an ordinary case when stability of the output, mechanical strength, response, etc, are taken into account.

The particle size of the ceramic support particles supporting the catalyst component is generally and preferably about 1 to about 30 μm. To secure a suitable response, the porosity of the catalyst layer 15 is at least 10% and is preferably from 30 to about 50%. When the support amount of the catalyst component is generally 200 μg/cm² or more, a sufficient effect of acquiring output stability can be obtained. To maintain catalyst performance for a long time, the support amount of the catalyst component is preferably large. When the support amount is large, on the other hand, the response is likely to drop. Therefore, it is generally preferred to keep the support amount of the catalyst component at 1 mg/cm² or below. As the catalyst component is directly supported by the substitution elements in the invention, the catalyst component is uniformly dispersed. Since aggregation does not occur so easily, good catalyst performance can be obtained with a relatively small catalyst support amount.

A trap layer 16 for protecting the catalyst from poisoning is further arranged on the upper surface of the catalyst layer 15. The trap layer 16 is formed, of ceramic particles having a particle size larger than the ceramic particles constituting the catalyst layer, into a porous shape, and collects catalyst-poisoning components inside the exhaust gas. Examples of the ceramic particles constituting the trap layer 16 are appropriately heat-resistant ceramic materials such as θ-alumina and cordierite. The thickness of the trap layer 16 is generally from about 50 to about 300 μm and its porosity is preferably from about 40 to about 80%.

The detection principle of the gas detection element having the construction described above will be explained. Referring to FIG. 1, the exhaust gas flowing through the trap layer 16, the catalyst layer 15 and the coating layer 14 is introduced into the outer electrode 13 of the gas concentration detection element 1, and atmospheric air is introduced into the inner electrode 12. An electromotive force is developed in the oxygen ion conductive solid electrolyte 11 in accordance with the difference of the oxygen concentration between the inner electrode 12 and the outer electrode 13. When this electromotive force is measured, the oxygen concentration in the exhaust gas can be measured. At this time, the gas components contained in the exhaust gas exhibit variance depending on the operating condition of the internal combustion engine and other conditions, and the catalytic operation of the catalyst layer 15 reduces the influences of this variance. Particularly because the catalyst components are chemically bonded to the catalyst layer 15 in this invention, degradation due to thermal aggregation does not easily occur, stable output characteristics can be maintained and durability can be drastically improved.

To evaluate the difference of performance between the gas detection element of the invention produced as described above and the gas detection element according to the prior art, a durability test is carried out under the following condition. Here, in the catalyst layer 15 of the gas detection element of the invention, W replaces a part of Al as the constituent element of cordierite and the Pt catalyst is chemically bonded to the support particles. In the gas detection elements of the prior art as Comparative Examples 1 and 2, the Pt catalyst is physically adsorbed to γ-alumina particles or θ-alumina particles. In the gas detection element of Comparative Example 2, the Pt catalyst is supported on the θ-alumina particles and is heat-treated at 900 to 1,100° C. so that the diameter of the catalyst particles becomes 1,000 Å or more. Each gas detection element is fitted to an internal combustion engine of an automobile having an exhaust capacity of 3,000 cc, and the change in the detection response to oxygen concentration is examined while the exhaust gas temperature is kept at 800 to 900° C. and the engine is continuously driven for 1,000 hours.

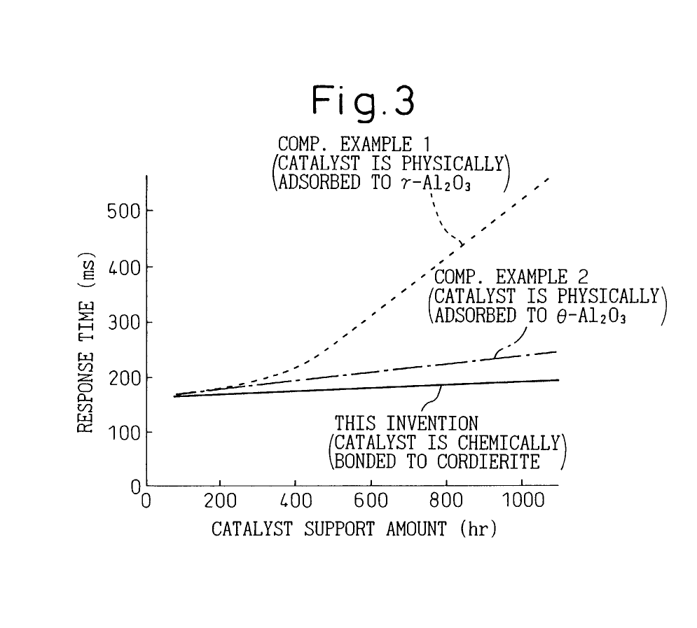

FIG. 3 shows the examination result of the relation between the operation time (durability time) and the detection response time of the oxygen concentration. As can be clearly seen from the drawing, the gas detection element of the invention has a small change of the response time even when the durability time is extended, and exhibits excellent durability as represented by a response time of not greater than 200 ms after the durability time of 1,000 hours. In contrast, the response time increases with an increase of the durability time in the gas detection element of Comparative Example 1, and the response time after the durability time of 1,000 hours exceeds 500 ms. In the support mechanism by physical adsorption according to the prior art, the bonding power is small, the catalyst components easily move and aggregate due to heat and γ-alumina itself undergoes thermal degradation. Therefore, the degradation is remarkable. On the other hand, the gas detection element of Comparative Example 2 has higher durability than that of Comparative Example 1 but the response time after the durability time of 1,000 hours exceeds 200 ms. The difference of performance from the invention becomes greater as the operation time becomes longer.

As described above, as the catalyst component is bonded by a strong chemical force in the gas detection element according to the invention, degradation of the catalyst with the passage of time is suppressed and the initial response can be maintained for a long time. As cordierite that has high heat resistance and is free from thermal degradation is used as the support, the durability can be greatly improved.

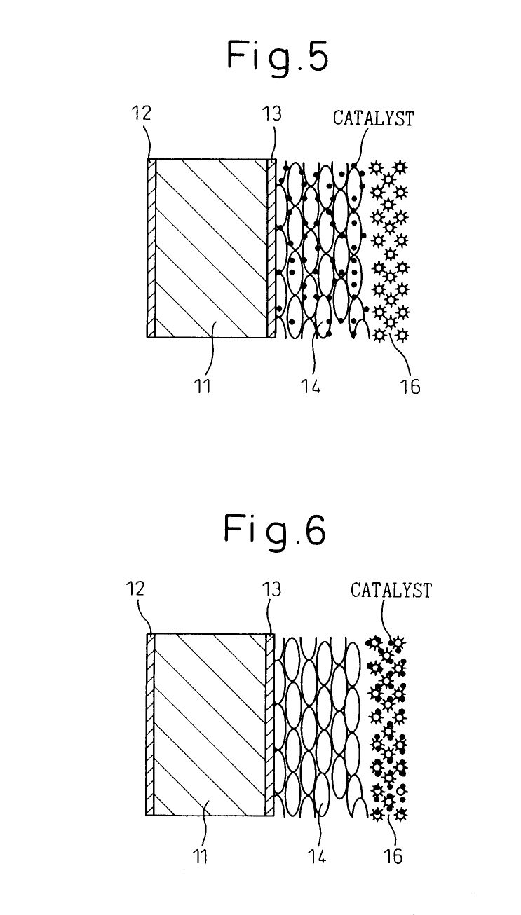

In the first embodiment described above, the catalyst layer 15 is interposed between the coating layer 14 and the trap layer 16 as shown in FIG. 1. However, it is also possible to let the ceramic particles constituting the coating layer 14 or the trap layer 16 support the catalyst component through chemical bond and to let them play the role of the catalyst layer as shown in FIGS. 5 or 6. In this case, too, cordierite capable of directly supporting the catalyst component through element substitution can be suitably used for the ceramic particles in the same way as the catalyst layer 15 described above.

In the first embodiment described above, the gas detection element 1 is used as the oxygen sensor by measuring electromotive force between the inner electrode 12 and the outer electrode 13 but can be used as an air-fuel ratio sensor for measuring an air-fuel ratio in a broader range. In such a case, too, the construction of the gas detection element 1 is substantially the same as the construction shown in FIG. 1, but the coating layer 14 functions as a diffusion resistance layer for introducing the exhaust gas as the measured gas into the outer electrode 13 with a predetermined diffusion resistance.

The detection principle of a threshold current type air-fuel ratio sensor having a diffusion resistance layer will be explained. When a voltage is applied between the inner electrode 12 and the outer electrode 13 disposed on both surfaces of the oxygen concentration detection element 1, the oxygen ions move inside the oxygen ion conductive solid electrolyte 11 in accordance with the difference of the oxygen concentration between both electrodes 12 and 13. Therefore, the air-fuel ratio can be detected from the threshold current flowing between both electrodes 12 and 13 when a predetermined voltage is applied between the electrodes 12 and 13.

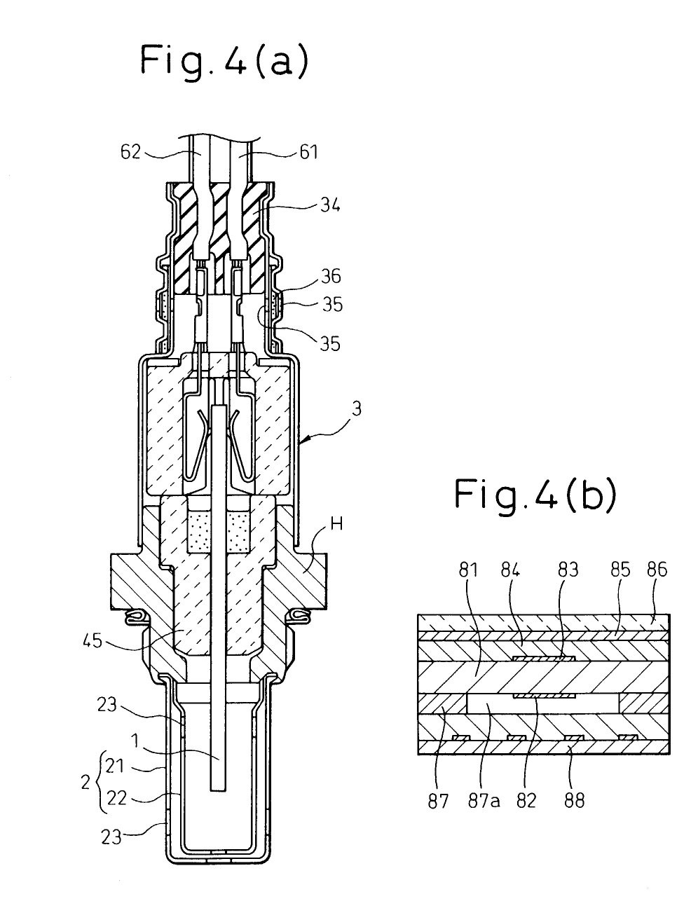

The embodiment given above explains the example of the gas concentration detection element 1 wherein the inner electrode and the outer electrode are respectively formed on the inner and outer peripheral surfaces of the oxygen ion conductive solid electrolyte having a substantially cup-like shape, but the shape of the gas concentration detection element 1 is not limited to this shape. For example, a laminate-type gas concentration detection element 1 may be used as shown in FIG. 4(a). In this case, a pair of electrodes are arranged on the upper and lower surfaces of a flat sheet-like oxygen ion conductive solid electrolyte 81 to oppose each other as shown in FIG. 8(b) so that the upper electrode 83 on the exhaust gas side and the lower electrode 82 on the atmospheric air side can be used, respectively, as a detection electrode and a reference electrode. A coating layer 84 is formed on the upper electrode 83, and a catalyst layer 85 and a trap layer 86 are further formed serially by lamination. A heater 88 is laminated on the lower surface of the lower electrode 82 through a flat sheet-like support 87 for forming an air passage 87a.

The construction and the detection principal of each of the electrodes 82 and 83, coating layer 84, catalyst layer 85 and trap layer 86 are the same as those of the embodiment described above, and the effect of improving the durability can be similarly obtained when the catalyst component of the catalyst layer 85 is supported through a chemical bond.

As described above, the invention can provide a gas detection element having higher durability than gas detection elements according to the prior art. When applied to an oxygen sensor or an air-fuel ratio sensor of an internal combustion engine, for example, the gas detection element can achieve high precision air-fuel ratio control. The invention is not particularly limited to the application of the oxygen sensor and the air-fuel ratio sensor, but can also be applied to the detection of gas components that can be indirectly detected from the change of the oxygen concentration in the gas.

What is claimed is:

1. A gas concentration detection element for detecting a specific gas component in a measured gas, including a catalyst layer formed outside a detection electrode, wherein said catalyst layer comprises ceramic support particles and a catalyst component supported by said ceramic support particles through chemical bond.

2. A gas concentration detection element according to claim 1, wherein said detection electrode is disposed on a surface of an oxygen ion conductive solid electrolyte in contact with said measured gas, and a reference electrode is disposed on a surface of said oxygen ion conductive solid electrolyte in contact with a reference gas.

3. A gas concentration detection element according to claim 1, wherein one or more kinds of elements constituting a substrate ceramic is substituted by an element other than the constituent elements in said ceramic support particles, and said catalyst component is directly supported on said substitution element.

4. A gas concentration detection element according to claim 3, wherein said substitution element is one or more kinds of elements having a d or an f orbit in the electron orbits thereof.

5. A gas concentration detection element according to claim 1, wherein said substrate ceramic contains cordierite as a principal component thereof.

6. A gas concentration detection element according to claim 1, which further includes a coating layer for covering a surface of said detection electrode.

7. A gas concentration detection element according to claim 6, which further includes a trap layer for collecting poisoning components outside said coating layer.

8. A gas concentration detection element according to claim 7, wherein said catalyst layer is formed between said coating layer and said trap layer.

9. A gas concentration detection element according to claim 6, wherein said coating layer or said trap layer functions also as said catalyst layer.

10. A gas concentration detection element according to claim 1, wherein said measured gas is an exhaust gas of an internal combustion engine and said specific gas component is oxygen.

11. A gas concentration detection element according to claim 2, which is used as an oxygen sensor by detecting an electromotive force developed between said detection electrode and said reference electrode, or as an air-fuel ratio sensor by detecting a threshold current flowing between said detection electrode and said reference electrode when a predetermined voltage is applied.
